(19) United States
(12) Patent Application Publication
(10) Pub. No.: US 2019/0018297 A1
(43) Pub. Date: Jan. 17, 2019

(54) ELECTROCHROMIC DEVICES

(71) Applicant: BASF SE, Ludwigshafen am Rhein (DE)

(72) Inventors: Michael Goebel, Neustadt (Weinstr.) (DE); Jens Roeder, Mannheim (DE); Fabian Seeler, Weinheim (DE); Maraike Ahlf, Schriesheim (DE); Ralf Noerenberg, Heidelberg (DE); Erich Beck, Ladenburg (DE)

(21) Appl. No.: 16/076,808

(22) PCT Filed: Feb. 7, 2017
(86) PCT No.: PCT/EP2017/052648

§ 371 Date: Aug. 9, 2018

(30) Foreign Application Priority Data
Feb. 11, 2016 (EP) 16155242.7

(51) Int. Cl. G02F 1/15; G02F 1/155

(52) U.S. Cl. CPC G02F 1/1525; G02F 1/155; G02F 2001/1515; G02F 2001/1519; G02F 2001/1555

(57) ABSTRACT

Described are electrochromic devices and compositions as well as manufacturing methods for making such electrochromic devices by printing or wet processing of the compositions. The compositions are in the form of a suspension and comprise two or more monomers, nanoparticles of an electrochromic metal oxide, one or more metal salts of the form (M)z(R)y, where M is a metal cation and R is the corresponding salt anion, a carrier liquid and a solvent. The compositions are polymerised to form a composite layer comprising a polymer matrix that hosts the electrochromic nanoparticles and the electrolyte. At least a part of the metal salts (e.g. zinc acetate) is physically adsorbed onto the surface of the nanoparticles and acts as a dispersant.

The present invention relates to the field of electrochromic devices. The invention further provides intermediate products and compositions suitable for manufacturing electrochromic devices. The invention also provides manufacturing methods for such intermediate products and electrochromic devices.

U.S. Pat. No. 8,593,714 B2 discloses an electrochromic device comprising a pair of electrodes separated by an electrolyte layer, wherein one of the said electrodes comprises an electrochromic material, an ion-conductive binder and conductive nanowires, and the said electrode is deposited by a printing process. More specifically, said electrode comprises particles which are electrochromic and are bound together with a binder which is generally ion conductive. This electrode also has a network of electronically conductive nanowires. Since nanowires are thin, these are still optically transparent. The electrochromic particles in said electrode may be large particles, or nanoparticles and may be of any shape. These particles may be rod like, spherical, disc like, cubes, etc.

U.S. Pat. No. 8,593,714 B2 does not provide detailed information regarding the manufacturing of an electrode comprising an electrochromic material, an ion-conductive binder and conductive nanowires, although this is not a trivial issue, at least due to the large number of different constituents (electrochromic material, nanowires, binder, ion conductor) which have to interact in such electrode in order to fulfill different functions (electrochromism, electronic conduction, ionic conduction, matrix-building). The large number of different constituents may cause problems with regard to their chemical compatibility. Furthermore, in order to allow expedient manufacturing of such electrodes by printing or other wet processing technique, compositions (also referred to as inks) are needed wherein the non-soluble constituents of the electrochromic composite layer (particles of electrochromic material as well as electronically conductive nanowires) are suspended, beside those constituents which are in the dissolved state. It is well known that suspensions of nanoobjects have limited stability because suspended nanoobjects tend to agglomerate.

Thus, it is an object of the present invention to mitigate at least some of these drawbacks of the state of the art. In particular, it is an aim of the present invention to provide compositions suitable for the formation of electrochromic composite layers on a plurality of substrates. It is a further aim to provide manufacturing methods for electrochromic composite layers avoiding vapor phase processes and to provide improved electrochromic devices and intermediate products for manufacturing electrochromic devices. It is a still further aim to provide electrochromic devices that are high performing and at the same time simple in manufacturing.

These objects are achieved by an electrochromic device according to a first aspect of the present invention, an intermediate product according to a second aspect of the present invention, a composition and its use according to a third aspect of the present invention and a manufacturing method according to a fourth aspect of the present invention. Further aspects and features of the invention are disclosed in the specification and independent claims, preferred embodiments are disclosed in the specification and the dependent claims.

The present invention will be described in detail below. It is understood that the various embodiments, preferences and ranges as provided/disclosed in this specification may be combined at will.

Unless otherwise stated, the following definitions shall apply in this specification:

The terms “a”, “an”, “the” and similar terms used in the context of the present invention are to be construed to cover both the singular and plural unless otherwise indicated herein or clearly contradicted by the context. Further, the terms “including”, “containing” and “comprising” are used herein in their open, non-limiting sense.

The term “electrochromic” is known in the art. Electrochromic materials are characterized by an ability to change their optical properties, reversibly, and persistently, when a voltage is applied across them (see Claes G. Granqvist, Solar Energy Materials & Solar Cells 99 (2012)1-13). This ability is herein also referred to as the “electrochromic effect”. More specifically, electrochromic materials have the property of exhibiting a change, evocation, or bleaching, of color (in the visible range of the electromagnetic spectrum) as effected either by an electron-transfer (redox) process or by a sufficient electrochemical potential (see Mortimer, R. J.: “Electrochromic materials”, Annu. Rev. Mater. Res. 2011. 41:241-68). A change of the optical absorption of the electrochromic material occurs when electrons are transferred to or away from the electrochromic material, along with charge balancing ions entering from an adjacent electrolyte.

The term “electrochromic device” is known in the art and refers to a device exploiting the effect of electrochromism. Such device comprises at least one electrode comprising an electrochromic material, a counter electrode and an ion conductive separator layer disposed between and electronically separating said electrodes. A widely known type of electrochromic devices are so-called smart windows. The term “smart windows” is known in the art.

The term electrochromic composite layer denotes a layer of an electrochromic device or an intermediate product for manufacturing an electrochromic device wherein said layer comprises discrete objects comprising electrochromic materials dispersed within a continuous phase (matrix) extending throughout said layer. Both, an electronically conductive network and an ionically conductive network extend throughout the electrochromic composite layer providing for the transport of electrons and ions to and away from the dispersed objects comprising electrochromic materials. Further constituents may be dispersed in the matrix, each fulfilling a specific function and interacting with the other constituents.

The term “physisorption” is known in the field and is defined as adsorption in which the forces involved are intermolecular forces (van der Waals or electrostatic forces) and which do not involve a significant change in the electronic orbital patterns of the species involved (see: “International Union of pure and Applied Chemistry” (http://goldbook.iupac.org/P04667.html). In the context of the present application it denotes the adsorption of a molecule or ion on a surface by either electrostatic or van der Waals attraction. In contrast to chemisorption, a physisorbed molecule or ion does not alter its chemical properties upon adsorption. Accordingly, by physisorption covalent bonds are neither formed nor broken nor are atoms ionized or ions deionized.

The term “nanoobject” is defined in ISO/TS 27687:2008 (as published in 2008) and refers to an object having one, two or three external dimensions in the nanoscale, i.e. in the size range from approximately 1 nm to 100 nm. As regards the nanoobjects comprising one or more electrochromic metal oxides, nanoobjects in the form of primary particles having three external dimensions in the nanoscale are preferred. According to ISO/TS 27687:2008 those types of nanoobjects are referred to as nanoparticles. According to DIN 53206-1: 1972-08, the term “primary particles” refers to entities which are discernible as individuals by means of optical microscopy or transmission electron microscopy. Preferred nanoparticles are approximately isometric, i.e. the aspect ratio (longest:shortest direction) of all 3 orthogonal dimensions is 1-2.

The term “nanowire” is defined in ISO/TS 27687:2008 (as published in 2008) and refers to an electronically conducting nanofiber. According to ISO/TS 27687:2008, nanofibers are nanoobjects with two similar external dimensions in the nanoscale and the third dimension significantly larger. The two similar external dimensions are considered to differ in size by less than three times and the significantly larger external dimension is considered to differ from the other two by more than three times. The largest external dimension is not necessarily in the nanoscale.

The term “electrolyte” is known in the art and denotes a substance which is capable of dissociating into mobile ions.

The term “suspension” is known and relates to a heterogeneous fluid of an internal phase (i.p.) that is a solid and an external phase (e.p.) that is a liquid (herein referred to as the carrier liquid). The suspension according to the present invention comprises further solid constituents, which are dissolved in the carrier liquid, and liquid constituents which are admixed to the carrier liquid.

The terms “dispersant” and “dispersing agent” are known in the field and have essentially the same meaning. In the context of the present invention, these terms denote a substance, which is used in suspensions to improve the separation of suspended particles and to prevent agglomeration or settling. In the context of the present invention the terms “dispersant” and “dispersing agent” are used for metal salts of formula (I) as defined below which stabilize the suspensions disclosed herein which comprise dispersed nanoobjects. The dispersant is different from the materials forming the liquid external phase of the suspension.

The term “wet-processing” is known in the field and denotes the application of a coating or thin film to a substrate by the use of a starting material comprising a liquid phase, e.g. a suspension.

The term “preformation” is known in the art and is used in the context of the present invention to generally denote treatments which serve to precondition the electrodes of an electrochromic device before, during and/or after device assembly in order to increase device performance and device stability by adjusting charge insertion/extraction in each electrode and charge balancing between these two electrodes. Suitable preformation treatments include, but are not limited to, chemical treatments (e.g. exposure to a gas e.g. ozone) and electrochemical treatments (e.g. application of a predetermined electrochemical potential for a predetermined duration, or subjecting the electrochromic material to one or more electrochromic switch cycles).

In a first aspect the invention relates to an electrochromic device, wherein said electrochromic device comprises a multitude of layers, comprising
an electrochromic composite layer
a substrate layer upon which the electrochromic composite layer is disposed,
a layer capable of reversibly inserting ions,
an ion conductive separator layer disposed between and electronically separating said electrochromic composite layer and said layer capable of reversibly inserting ions,

wherein said electrochromic composite layer comprises
a matrix formed of one or more organic polymers and dispersed within said matrix:
nanoobjects comprising one or more electrochromic metal oxides,
one or more metal salts of formula (I) as defined hereinbelow
wherein at least a portion of said metal salts of formula (I) is physisorbed on the surfaces of said nanoobjects comprising one or more electrochromic metal oxides
optionally electronically conductive nanowires and
one or more electrolytes having cations selected from the group consisting of H⁺, Li⁺, Na⁺ and K⁺ dissolved in a solvent having a boiling point of 120° C. or higher.

The term electrochromic device is defined above.

The electrochromic device according to the invention comprises at least one electrochromic composite layer as defined above. The constituents of the electrochromic composite layer and their respective functions within said electrochromic composite layer are explained in further detail below.

Matrix Formed of One or More Organic Polymers

The electrochromic composite layer of the electrochromic device according to the present invention comprises a matrix formed of one or more organic polymers (hereinbelow also referred to as “organic polymer matrix”). The term “polymers” as used herein includes co-polymers (polymers obtained by co-polymerization of two or more kinds of co-polymerizable monomers).

The term “matrix” is defined above.

Preferably, said organic polymers forming said matrix are copolymerisation products of monomers selected from the group consisting of alkyl (meth)acrylates and monomers selected from the group of hydroxyalkyl (meth)acrylates. As used herein, the term (meth)acrylates in each case includes acrylates and methacrylates.

Within the electrochromic composite layer, the matrix provides mechanical integrity and stability and binds and accommodates certain constituents of the electrochromic composite layer which are dispersed within said matrix. Said constituents dispersed within said matrix are:
nanoobjects comprising one or more electrochromic metal oxides,
one or more metal salts of formula (I) as defined below
optionally electronically conductive nanowires and
one or more electrolytes comprising cations selected from the group consisting of H⁺, Li⁺, Na⁺ and K⁺ dissolved in a solvent having a boiling point of 120° C. or higher.

These constituents shall be explained in further detail below.

Nanoobjects Comprising One or More Electrochromic Metal Oxides

According to the present invention, the electrochromic composite layer comprises nanoobjects comprising one or more electrochromic metal oxides dispersed within said organic polymer matrix. The terms “nanoobjects” and “electrochromic” are defined above. Said nanoobjects comprising one or more electrochromic metal oxides are hereinbelow also referred to as “metal oxide nanoobjects”.

Electrochromic metal oxides are known in the art, see e.g. Mortimer, R. J.: “Electrochromic materials”, Annu. Rev. Mater. Res. 2011. 41:241-68 and Granqvist, C. G.: “Oxide electrochromics: An introduction to devices and materials”, Solar Energy Materials & Solar Cells 99 (2012) 1-13. The electrochromic metal oxides are preferably selected from the group consisting of oxides of Ti, V, Cr, Mn, Fe, Co, Ni, Nb, Mo, Rh, Ta, W and Ir and mixtures thereof. Preferred are oxides of Ti, V, Ni, Nb, Mo, Ta and W and mixtures thereof.

In the electrochromic device according to the present invention, the electrochromic effect of the electrochromic metal oxide is effected by applying an appropriate electrochemical potential so that a change of the oxidation state (anodic oxidation or cathodic reduction) of the metal in the electrochromic metal oxide occurs which is accompanied by an electrochromic effect as defined above. In at least one of the involved oxidation states, the electrochromic metal oxide exhibits a color falling within the visible range of the electromagnetic spectrum (380 nm-780 nm).

A nanoobject comprising one or more electrochromic metal oxides dispersed in the electrochromic composite layer according to the present invention may consist of one or more electrochromic metal oxides. In this case, no other materials than electrochromic metal oxides are present within such nanoobjects.

Alternatively, a nanoobject comprising one or more electrochromic metal oxides for the electrochromic composite layer according to the present invention may consist of one or more electrochromic metal oxides and one or more other metal oxides which are not electrochromic. Preferably, said one or more metal oxides which are not electrochromic are selected from the group consisting of oxides of Si, Ce, Y, Pr, Nd, Sm, Eu, Hf, Zr, Ca, Zn, Sn, Ag, Cd, La, Pb and In and mixtures thereof.

Preparation of suitable metal oxide nanoobjects comprising one or more electrochromic metal oxides is known in the art (see below).

Preferred metal oxide nanoobjects oxides are metal oxide nanoparticles (nanoparticles comprising one or more electrochromic metal oxides). The term “nanoparticles” is defined above. Particularly preferred are particles having a primary particle diameter of 1 nm to 100 nm, preferably 3 nm to 50 nm (measured by nitrogen absorption, X-Ray diffraction or transmission electron microscopy).

Preferably, said nanoobjects comprising one or more electrochromic metal oxides exhibit a bimodal or multimodal size distribution. It is believed that bimodal or multimodal size distributions result in higher particle packing densities, thus resulting in lower layer porosity.

Metal Salts of Formula (I):

According to the present invention, one or more metal salts of formula (I) as defined below are present in the electrochromic composite layer. At least a portion of said metal salts of formula (I) is physisorbed on the surface of the metal oxide nanoobjects. The term physisorbed is defined above. It is apparent that physisorption mainly takes place on the surface of the metal oxide nanoobjects. Without being bound to theory, it is believed the metal salts of formula (I) as defined herein (see below) act as dispersants with regard to the above-defined metal oxide nanoobjects. In the context of the present application, metal salts of formula (I) as defined hereinbelow are therefore also referred to as dispersants. The term dispersant is defined above.

The molar fraction of metal in the metal ions M of the metal salts of formula (I) is in the range of from 0.02 to 6 mol %, based on the total amount of metal (i) in the metal ions M of the metal salts of formula (I) and (ii) in the metal oxides in the metal oxide nanoobjects. In this regard, any metal oxide present in the metal oxide nanoobjects is considered irrespective whether it is electrochromic or not.

The specific molar fraction of the metal salts of formula (I) may depend on the specific surface exhibited by the nanoobjects and may be determined by the skilled person.

According to the present invention, the metal salt is of formula (I)

(M^{a+})_{z}(R^{b-})_{y} (I)

wherein

M^{a+} represents a metal cation,

R^{b-} represents the corresponding salt anion,

a is 2, 3, 4 or 5,

b is 1, 2 or 3,

z is the least common multiple of a and b, divided by a

y is the least common multiple of a and b, divided by b.

Thus, when a is 2 and b is 1, z is 1 and y is 2.

Thus, when a is 2 and b is 2, z is 1 and y is 1.

Thus, when a is 2 and b is 3, z is 3 and y is 2.

Thus, when a is 3 and b is 1, z is 1 and y is 3.

Thus, when a is 3 and b is 2, z is 2 and y is 3.

Thus, when a is 3 and b is 3, z is 1 and y is 1.

Thus, when a is 4 and b is 1, z is 1 and y is 4.

Thus, when a is 4 and b is 2, z is 1 and y is 2.

Thus, when a is 4 and b is 3, z is 3 and y is 4.

Thus, when a is 5 and b is 1, z is 1 and y is 5.

Thus, when a is 5 and b is 2, z is 2 and y is 5.

Thus, when a is 5 and b is 3, z is 3 and y is 5.

Preferred are metal salts of formula (I) wherein

M represents one of Zn, Al, Sc, Ga, Y, Pb, Bi, Cu, Ni, Co, Fe, Mn, Cr, V, Ti, La, Mg, Ca, Sr and Ba, most preferably one of Zn, Al and Y

or

R^{b-} represents an organic anion selected from the group consisting of acetate, formiate, citrate, and oxalate, or an inorganic anion selected from the group consisting of nitrate, difluorophosphate, hexafluorophosphate and tetrafluoroborate.

More specifically, preferred are metal salts of formula (I) wherein

M represents one of Zn, Al, Sc, Ga, Y, Pb, Bi, Cu, Ni, Co, Fe, Mn, Cr, V, Ti, La, Mg, Ca, Sr and Ba, most preferably one of Zn, Al and Y

and

R^{b-} represents an organic anion selected from the group consisting of acetate, formiate, citrate, and oxalate, or an inorganic anion selected from the group consisting of nitrate, difluorophosphate, hexafluorophosphate and tetrafluoroborate.

Especially preferred metal salts of formula (I) are zinc diacteate, aluminium triacetate, yttrium triacetate, zinc dinitrate, aluminium trinitrate, and yttrium trinitrate.

It is preferred that in an electrochromic composite layer of an electrochromic device according to the present invention the metals M of the dispersant salts of formula (I) differ from the metals of the metal oxides in the metal oxide nanoobjects.

The metal salts described herein are commercial items. Such metal salts may be made by any method known in the art.

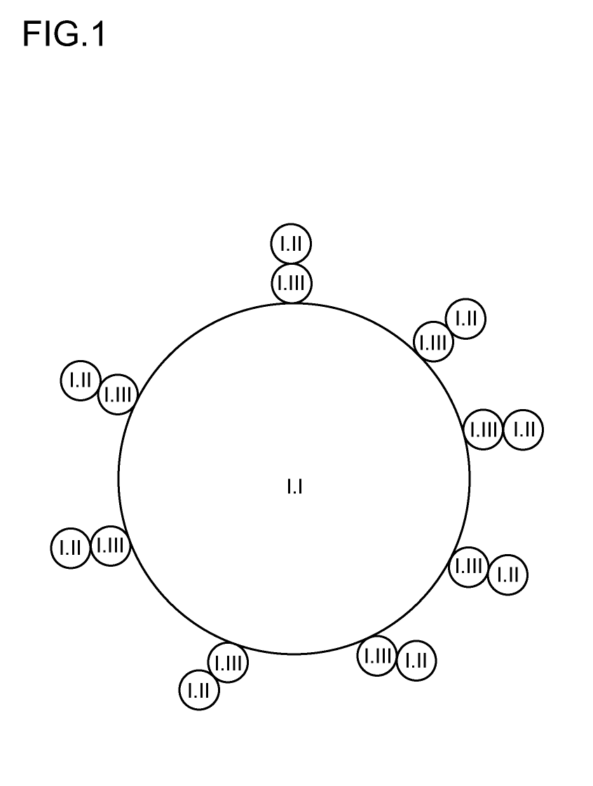

FIG. 1 shows a schematic illustration of a single metal oxide nanoobject in the form of a metal oxide nanoparticle (I.I) with a metal salt of formula (I) (cation I.III and anion I.II) physisorbed on its surface. Without being bound to theory, it is believed that the positively charged metal salt cation (I.III) will physisorb onto the negatively charged surface of metal oxide nanoparticle (I.I) and that the negatively charged anion (I.II) is present bound to the cation (as shown). In case the metal oxide particle is dispersed in a liquid phase, e.g. in the suspension according to the third aspect of the present invention, the anion may also be spatially separated (not shown).

In one embodiment, said metal oxide nanoobjects are coated with one type of dispersant (metal salt of formula (I)) as defined herein. In one alternative embodiment, said metal oxide nanoobjects are coated with two or more types of dispersant (metal salts of formula (I)) as defined herein. In this embodiment, either an individual metal oxide nanoobject is coated with said two or more types of dispersant or a first group of metal oxide nanoobjects is coated with a first dispersant, a second group of metal oxide nanoobjects is coated with a second dispersant and so on.

Electronically Conductive Nanowires

According to the present invention, the electrochromic composite layer optionally comprises electronically conductive nanowires dispersed within said organic polymer matrix.

In certain cases, the electrochromic composite layer comprises electronically conductive nanowires dispersed within said organic polymer matrix.

The term “nanowires” is defined above.

Without being bound to theory, it is believed that the electronically conductive nanowires form a network extending throughout the electrochromic composite layer providing for the transport of electrons to and away from the metal oxide nanoobjects when an external electric voltage is applied to the electrochromic device.

Preferably, said electronically conductive nanowires are nanowires consisting of materials selected from the group consisting of silver, copper, gold, platinum, tungsten and nickel and alloys of two or more metals selected from silver, copper, gold, platinum, tungsten and nickel.

Preferably said electronically conductive nanowires have a length in the range of from 1 μm to 100 μm, and a diameter in the range of from 1 nm to 100 nm, preferably 10 nm to 50 nm, most 5 preferably 15 nm to 30 nm, length and diameter in each case being determined by transmission electron microscopy.

Suitable nanowires are commercially available.

Electrolytes Having Cations Selected from the Group Consisting of H⁺, Li⁺, Na⁺ and K⁺ Dissolved in a Solvent Having a Boiling Point of 120° C. or higher

According to the present invention, the electrochromic composite layer comprises one or more electrolytes having cations selected from the group consisting of H⁺, Li⁺, Na⁺ and K⁺ and a solvent having a boiling point of 120° C. or higher dispersed within said matrix formed of one or more organic polymers. Said electrolytes comprising a cation selected from the group consisting of H⁺, Li⁺, Na⁺ and K⁺ are dissolved in or mixed with said solvent.

The term “electrolyte” is defined above.

When dissolved in the solvent the electrolytes are at least partly dissociated into mobile ions, thus providing for ionic conductivity in the electrochromic composite layer. Without being bound to theory, it is believed that in the electrochromic composite layer of the electrochromic device according to the present invention said solvent including said dissolved electrolytes having cations selected from the group consisting of H⁺, Li⁺, Na⁺ and K⁺ is confined within pores extending through the matrix, thus providing a network for the transport of ions to and away from the metal oxide nanoobjects when an electric voltage is applied to the electrochromic device.

The electrolytes are selected so that their anions are not electroactive in the range of electrochemical potentials typically applied for operating the electrochromic device. Preferred electrolytes are selected from the group consisting of bis(trifluoromethane) sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, water and lithium difluorobisoxalatophosphate.

The solvent for dissolving the electrolyte is selected to have a boiling point of 120° C. or higher, in order to allow the solvent to remain in the electrochromic composite layer which is manufactured by wet processing, i.e. by forming a wet film on a surface of a substrate by applying a suspension comprising a carrier liquid having a boiling point of less than 120° C. and subsequent removing of said carrier liquid from the wet film.

Due to the requirement of dissolution and dissociation of the electrolyte, suitable solvents are polar solvents. Preferred solvents are selected from the group consisting of acyclic carbonates, alkyl esters of saturated carbonic acids, polyethers, lactones and dinitriles and mixtures thereof.

According to the present invention, it is not excluded that a fraction of the one or more metal salts of formula (I) as defined above is also partly dissolved in the solvent having a boiling point of 120° C. or higher.

In an electrochromic device according to the present invention, said electrochromic composite layer has a thickness in the range of from 0.05 μm to 500 μm, preferably of from 0.05 μm to 50 μm, most preferably of from 1 μm to 30 μm. Thickness may be determined by profilometry, atomic force microscopy or electron microscopy.

In the electrochromic device according to the present invention, the above-described electrochromic composite layer is disposed on a substrate layer. Depending on the specific type of electrochromic device, the substrate may be transparent or non-transparent. Typically said substrate layer comprises one or more materials selected from the group consisting of glasses, metals and organic polymers.

Preferred types of glass are e.g. float glass, low iron float glass, heat strengthened glass and chemically strengthened glass. Optionally, the glass has a low-emissivity (low-e) coating, sun-protection coating or any other coating on the surface facing away from the electrochromic composite layer.

Preferred organic polymers are selected from the group consisting of polymethylmethacrylate (PMMA, commercially available e.g. as Plexiglas™), polycarbonate (PC), polyethylene (PE), low density polyethylene (LDPE), linear low density polyethylene (LLDPE), polypropylene (PP), low density polypropylene (LDPP), polyethylene therephthalate (PET), glycol modified polyethylene therephthalate, polyethylene napthalate (PEN), cellulose acetate butyrate, polylactide (PL), polystyrene (PS), polyvinyl chloride (PVC), polyvinylbutyral (commercially available e.g. as Mowital LPBF™, Trosifol OG™), ethylene-vinylacetate-copolymers (EVA), polyurethanes (PU), ionomer resins (commercially available e.g. Sentryglas™)

Depending on the type of the electrochromic device, said solid substrate is in a form selected from the group consisting of foils, films, webs, panes and plates. With regard to efficiency of manufacturing of electrochromic devices, rollable substrates (substrates which are sufficiently flexible to be taken up on a roll and returned to flatness in an undamaged state), e.g. foils and films, are preferred, so as to enable implementation of continuous, e.g. roll-to-roll processing steps in manufacturing of electrochromic devices.

Preferably, said solid substrate has a thickness in the range of from 0.1 μm to 1000 μm, preferably 1 μm to 500 μm and more preferably from 50 μm to 200 μm.

In some cases, the surface of the substrate layer upon which the electrochromic composite layer is disposed comprises an electronically conductive material, preferably an optically transparent electronically conductive material. Preferred optically transparent conducting materials are transparent conducting oxides (TCO), preferably selected from the group consisting of ITO (indium doped tin oxide), AZO (aluminum doped zinc oxide), IGZO (indium gallium doped zinc oxide), GZO (gallium doped zinc oxide), FTO (fluorine doped tin oxide), indium oxide, tin oxide and zinc oxide. In some cases, the surface of the substrate layer upon which the electrochromic composite layer is disposed comprises one or more metallic electronically conductive materials, wherein the metals are preferably selected from the group consisting of Cu, Ag, Au, Pt and Pd. Preferably, the metal at the substrate surface is present in the form of a structure which is optically transparent, e.g. in the form of nanowires.

However, it has been found that in certain preferred embodiments of the present invention wherein the electrochromic composite layer comprises electronically conductive nanowires dispersed within said organic polymer matrix the electronic in-plane conductivity of the electrochromic composite layer is sufficiently high so that providing the substrate surface with an electronically conductive material can be omitted. This is an important advantage because manufacturing of the electrochromic device is facilitated and the costs are reduced.

The electrochromic device further comprises
a layer capable of reversibly inserting ions, and
an ion conductive separator layer disposed between and electronically separating said electrochromic composite layer and said layer capable of reversibly inserting ions.

Upon operation of the electrochromic device the electrochromic composite layer and the layer capable of reversibly inserting ions are connected to a direct voltage source in such manner that said layer capable of reversibly inserting ions acts as counter electrode with regard to the electrochromic composite layer. “Capable of reversibly inserting ions” herein means that the layer acting as the counter electrode is capable of repeatedly inserting and releasing ions to compensate for changes of the oxidation state of the metal of the electrochromic metal oxide in the metal oxide nanoobjects present in the electrochromic composite layer. Between the electrochromic composite layer and the counter electrode, virtually no electrons are transferred across the ion conductive separator layer.

The ion conductive separator layer preferably has a thickness in the range of from 0.05 μm to 500 μm, preferably 0.05 μm to 50 μm, most preferably 1 μm to 50 μm.

Said layer capable of reversibly inserting ions is typically disposed on a substrate. Statements made above regarding specific and preferred features of the substrate on which the electrochromic composite layer is disposed apply also to the substrate on which said layer capable of reversibly inserting ions is disposed.

Said layer capable of reversibly inserting ions acting as counter electrode with regard to the electrochromic composite layer may comprise an electroactive material which independent from its state of oxidation is substantially optically transparent or has an electrochromic effect significantly less pronounced than that of the electrochromic metal oxide in the metal oxide nanoobjects of the electrochromic composite layer. Suitable electroactive materials are known in the art and include, but are not limited to tin oxide, cerium oxide, transparent polymers capable of intercalating lithium ions and crystalline WO₃.

Alternatively, said layer capable of reversibly inserting ions acting as counter electrode with regard to the electrochromic composite layer comprises an electroactive material which is an electrochromic material exhibiting an electrochromic effect having a dependence on the applied electrochemical potential which is opposite to the electrochromic effect of the electrochromic metal oxide in the electrochromic composite layer. For instance, the electrochromic oxide of the electrochromic composite layer colors during anodic oxidation and discolors during cathodic reduction, and the electrochromic material in the counter electrode colors during cathodic reduction and discolors during anodic oxidation, or vice versa. Alternatively, the electrochromic oxide of the electrochromic composite layer adopts a dark color during anodic oxidation and a less dark color during cathodic reduction, and the electrochromic material in the counter electrode adopts a dark color during cathodic reduction and a less dark color during anodic oxidation, or vice versa.

Herein, preferably said layer capable of reversibly inserting ions acting as counter electrode with regard to the electrochromic composite layer is an electrochromic composite layer as defined above, so that the electrochromic device comprises a first electrochromic composite layer and a second electrochromic composite layer as defined above and an ion conductive separator layer disposed between and electronically separating said first and second electrochromic composite layer. Statements made above regarding specific and preferred features of the first electrochromic composite layer apply also to the second electrochromic composite layer.

A preferred electrochromic device according to the present invention comprises a multitude of layers said multitude of layers consisting of (in the order of stacking):
a first substrate
an electrochromic composite layer disposed on said first substrate
an ion conductive separator layer
a layer capable of reversibly inserting ions
a second substrate on which said layer capable of reversibly inserting ions is disposed.

A further preferred electrochromic device according to the present invention comprises a multitude of layers as defined above laminated to a support layer. An alternative preferred electrochromic device according to the present invention comprises a multitude of layers as defined above laminated in a sandwich-like manner between a first support layer and a second support layer. Said support layers preferably comprise one or more materials selected from the group consisting of glasses, metals and organic polymers.

Adhesion between the support layer and the multitude of layers as defined above may be achieved by means of applying a suitable adhesive, preferably in the form of an adhesive layer applied between the surface of the support layer and the surface of the above-defined multitude of layers. Suitable adhesives are thermoplastics, e.g. polyvinylbutyral polyvinylalcohol, polyvinylacetate, ethylene-vinylacetate-copolymers, polyurethanes, ionomer resins (commercially available e.g. under the trade name SentryGlas®) and polymethylmethacrylate (PMMA).

Preferred electrochromic devices are selected from the group consisting of
facade and roof elements, e.g. windows (also referred to as “smart windows”), insulation glass units, skylights, roof windows etc.
windows in transportation vehicles for e.g. aircrafts, trains, cars and trucks,
interior construction and design elements for buildings or vehicles, e.g. shower cabins, doors, separation elements, head up displays, cabin walls, room dividers etc.
displays and visualization optics, e.g. for computers, laptops, monitors, cell phones, vehicles, head up displays, dynamic backplanes as part of displays and tablet personal computers
electrochromic mirrors, e.g. rear view mirrors for vehicles,
sunglasses for daylight and night scopes.

Preferred electrochromic devices according to the present invention are those wherein two or more of the above-defined preferred features are combined.

In a second aspect the invention relates to an intermediate product for manufacturing an electrochromic device according to the first aspect of the present invention.

Said intermediate product according to the second aspect of the present invention comprises an electrochromic composite layer as defined above with regard to the first aspect of the present invention and a substrate layer upon which the electrochromic composite layer is disposed.

In a specific embodiment, said intermediate product further comprises an ion conductive separator layer disposed on said electrochromic composite layer.

In a further specific embodiment, said intermediate product comprises a multitude of layers consisting of (in the order of stacking):
a first substrate
an electrochromic composite layer disposed on said first substrate
an ion conductive separator layer
a layer capable of reversibly inserting ions
a second substrate on which said layer capable of reversibly inserting ions is disposed
optionally an adhesive layer on the surface of the first substrate which faces away from the electrochromic composite layer and/or an adhesive layer on the surface of the second substrate which faces away from the layer capable of reversibly inserting ions, wherein said adhesive layers are preferably covered by removable protecting layers.

An intermediate product according to the second aspect of the present invention differs from an electrochromic device according to the first aspect of the present invention in that in said intermediate product one or more elements which are necessary for the function of an electrochromic device (e. g. electrical connections, switches, controlling units, supporting structures) are not present. An electrochromic device according to the first aspect of the present invention is obtainable by adding said missing elements to said intermediate product. Accordingly, an electrochromic device according to the first aspect of the present invention comprises said intermediate product according to the second aspect of the present invention. Said transformation of the intermediate product according to the second aspect of the present invention into an electrochromic device according to the first aspect of the present invention is herein referred to as “finishing”. Said finishing may also comprise a preformation of electrochromic layers, if necessary. The term preformation is defined above.

As outlined above, there is a need for an efficient manner of manufacturing electrochromic devices. This can be achieved by means of the intermediate products according to the present invention. Accordingly, an intermediate product is manufactured including suitable wet-processing technique, such as coating or printing; the thus obtained intermediate product is then finished to obtain the final product (i.e. the electrochromic device).

As regards the substrates, the electrochromic composite layer, the ion conductive separator layer and the layer capable of reversibly inserting ions, reference is made to the description provided in the context of the first aspect of the present invention. Statements regarding specific and preferred features of the substrates, the electrochromic composite layer, the ion conductive separator layer and the layer capable of reversibly inserting ions made above in context with the first aspect of the present invention also apply to the second aspect of the present invention.

An intermediate product according to the present invention may further comprise auxiliary constituents which serve one or more purposes like protection and easy handling, wherein such auxiliary constituents are removed during finishing, i.e. do no become part of the electrochromic device. Such auxiliary constituents are e.g. removable support layers, removable protection layers, removable separation layers, bobbins for rolling etc.

Preferred intermediate products according to the present invention are those wherein two or more of the above-defined preferred features are combined.

In this second aspect, the present invention also relates to the use of an intermediate product according to the second aspect of the present invention for manufacturing an electrochromic device according to the first aspect of the present invention.

An electrochromic device according to the first aspect of the present invention as well as an intermediate product according to the second aspect of the present invention are herein commonly referred to as “product according to the present invention”.

In a third aspect the invention relates to a composition in the form of a suspension, and the use of said composition for manufacturing an electrochromic device or an intermediate product according to the present invention.

A composition in the form of a suspension according to the present invention comprises
(a) nanoobjects comprising one or more electrochromic metal oxides
(b) one or more metal salts of formula (I) as defined above
(c) a non-polymerizable carrier liquid having a boiling point of less than 120° C.,
(d) optionally electronically conductive nanowires
(e) two or more kinds of co-polymerizable monomers
(f) one or more electrolytes having cations selected from the group consisting of H⁺, Li⁺, Na⁺ and K⁺
(g) a solvent having a boiling point of 120° C. or higher capable of dissolving said one or more electrolytes (f).

Thus, a composition in the form of a suspension according to the present invention comprises
precursors (in the form of two or more kinds of co-polymerizable monomers) of the organic polymer matrix of the electrochromic composite layer, and
the above-defined constituents of an electrochromic composite layer which are to be dispersed within said organic polymer matrix
a non-polymerizable carrier liquid having a boiling point of less than 120° C. which does not become a constituent of the electrochromic composite layer but merely acts as a vehicle for wet-processing.

The non-polymerizable carrier liquid having a boiling point of less than 120° C. is preferably selected from the group consisting of water, methanol, ethanol, propanol, 1-propanol, 2-propanol, 2-butanol, iso-butanol, acetonitrile and propionitrile and mixtures thereof.

With regard to the constituents
(a) nanoobjects comprising one or more electrochromic metal oxides
(b) one or more metal salts of formula (I) as defined above
(d) electronically conductive nanowires
(f) one or more electrolytes having cations selected from the group consisting of H⁺, Li⁺, Na⁺ and K⁺
(g) a solvent having a boiling point of 120° C. or higher capable of dissolving said one or more electrolytes (f)

reference is made to the description provided in the context of the first aspect of the present invention. Statements made above regarding specific and preferred features of the substrate apply also to the third aspect of the invention.

Suitable co-polymerizable monomers for forming an organic polymer matrix are known in the art and are commercially available. Preferred are monomers selected from the group consisting of alkyl acrylates and alkyl methacrylates (first kind of monomers) and monomers selected from the group of hydroxyalkyl acrylates and hydroxyalkyl methacrylates (second kind of monomers).

Without being bound to theory, it is believed that in the composition according to the third aspect of the present invention the metal salts of formula (I) as defined above act as dispersants for the nanoobjects (a) and are at least partly physisorbed on the surface of the metal oxide nanoobjects and may be partly dissolved in the liquid phase of the suspension. In other words, in a suspension according to the third aspect of the present invention the surfaces of the nanoobjects (a) are at least partly coated with metal salts of formula (I). The specific fractions of metal salt physisorbed on the surface of the metal oxide nanoobjects and dissolved in the in the liquid phase of the suspension are dependent on the specific combination of metal oxide nanoobjects/metal salts of formula (I).

Advantageously, the metal oxide nanoobjects are nanoparticles which in suspension have a hydrodynamic size D₉₀ of less than 100 nm (measured by dynamic light scattering or centrifugal sedimentation techniques).

Advantageously, the metal oxide nanoobjects are nanoparticles synthesized by a gas phase pyrolysis process, preferably flame spray synthesis. Such nanoparticles are commercially available.

The manufacturing of suspensions is a known procedure. The coating of nanoobjects is also a known procedure.

In one embodiment, solvent and nanoobjects are combined, for example by mixing, ultrasonication or ball milling. To the obtained initial suspension, the dispersants (metal salts of formula (I) as defined above) are added. Coating of the nanoobjects with the metal salt of formula (I) as defined above takes place during mixing at room temperature or upon heating.

In one alternative embodiment, solvent and dispersants (i.e. metal salts) are combined, for example by mixing. To the obtained initial solution, the nanoobjects are added. Coating of the nanoobjects with the metal salt of formula (I) as defined above takes place during mixing at room temperature or upon heating.

A composition in the form of a suspension according to the third aspect of the present invention may be used for manufacturing of an intermediate product according to the second aspect of the present invention and for manufacturing an electrochromic device according to the first aspect of the present invention.

More specifically, a composition in the form of a suspension according to the third aspect of the invention may be used for manufacturing an electrochromic composite layer of an intermediate product according to the second aspect of the present invention and for manufacturing an electrochromic composite layer of an electrochromic device according to the first aspect of the present invention.

Preferred compositions according to the present invention are those wherein two or more of the above-defined preferred features are combined.

In a fourth aspect, the invention relates to methods of manufacturing of intermediate products according to the second aspect and electrochromic devices according to the first aspect of the present invention. According to the fourth aspect of the present invention, manufacturing of the intermediate products and electrochromic devices according to the present invention includes wet-processing steps. This is considered a significant advantage, as it enables manufacturing electrochromic composite layers of electrochromic device by simple technologies applicable to large areas and continuous processing.

In said methods for manufacturing an electrochromic device or an intermediate product according to the present invention, manufacturing the electrochromic composite layer comprises the steps of
(i) forming on a surface of a substrate a wet film by applying a suspension according to the third aspect of the invention to said surface of said substrate layer
(ii) removing the non-polymerizable carrier liquid having a boiling point of less than 120° C. from said wet film formed on the surface of said substrate layer and
(iii) initiating and allowing to proceed copolymerization of said two or more kinds of co-polymerizable monomers on the surface of said substrate layer.

In step (i) a wet film is formed on the substrate surface which contains
precursors (in the form of two or more kinds of co-polymerizable monomers) of the organic polymer matrix of the electrochromic composite layer, and
the above-defined constituents of an electrochromic composite layer which are to be dispersed within said organic polymer matrix
a non-polymerizable carrier liquid having a boiling point of less than 120° C.

In step (ii), the non-polymerizable carrier liquid having a boiling point of less than 120° C., which is not a constituent of the electrochromic composite film but merely a vehicle for wet processing, is removed from the wet film, and in step (iii), the organic polymer matrix is formed by copolymerization of said two or more kinds of co-polymerizable monomers. In this way, an electrochromic composite layer is obtained which comprises
an organic polymer matrix and
dispersed within said organic polymer matrix:
   nanoobjects comprising one or more electrochromic metal oxides,
   one or more metal salts of formula (I) as defined above
   wherein at least a portion of said metal salts is physisorbed on the surfaces of said nanoobjects
   optionally electronically conductive nanowires and
   one or more electrolytes having cations selected from the group consisting of H⁺, Li⁺, Na⁺ and K⁺ dissolved in a solvent having a boiling point of 120° C. or higher.

In step (i), application of the suspension according to the third aspect of the invention to a surface of a substrate layer may be achieved by means of coating and/or printing techniques. Suitable are, for example coating, particularly roll-to-roll-, slot-die-, spray-, ultra-sonic spray-, dip-, reel-to-reel-, blade- coating; or printing, particularly ink-jet-, pad-, offset-, gravure-, screen-, intaglio-, sheet-to-sheet- printing. These techniques are known in the art and are commercially available. Such processes are generally considered advantageous for large scale production, when compared to vacuum-based processes.

Statements made above regarding specific and preferred features of the substrate apply also to the fourth aspect of the invention.

Statements regarding specific and preferred features of the suspension according to the third aspect of the present invention also apply to the fourth aspect of the present invention.

In step (ii) removing the non-polymerizable carrier liquid having a boiling point of less than 120° C. from said wet film formed on the surface of said substrate layer may take place at room temperature or elevated temperature, under air or under a protecting gas, such as nitrogen or argon. Especially suited are gases with low humidity content (e.g. nitrogen, dry air, argon).

Water as the electrolyte of the electrochromic composite layer may be introduced by using a carrier liquid (c) consisting of water and another liquid having a boiling point of less than 120° C. (e.g. ethanol or 2-propanol). In the suspension according to the present invention, said carrier liquid (c) and said solvent (g) having a boiling point of 120° C. or more (e.g. propylene carbonate) form a single liquid phase. The amount of water that remains in said system consisting of water and two other liquids (one having a boiling point of less than 120° C. and one having a boiling point of 120° C. or higher) can be estimated according to Raoult's law or can be determined from experimental data, as known by the skilled person.

In step (iii) said copolymerization may be initiated by irradiation, especially UV irradiation in the presence of an initiator which decomposes into radicals when exposed to irradiation, especially UV irradiation (UV-initiator). Suitable copolymerization initiators are known in the art and commercially available.

In a preferred method according to the present invention

in step (i) the suspension is applied by coating or printing;

and

in step (ii) the non-polymerizable carrier liquid having a boiling point of less than 120° C. is removed under air or a protecting gas;

and

in step (iii) said copolymerization is initiated by irradiation, especially UV-irradiation in the presence of an initiator which decomposes into radicals when exposed to UV irradiation.

Optionally, after completion of step (iii), the sequence consisting of steps (i) to (iii) is repeated once ore several times, until the desired thickness of the electrochromic composite layer is achieved.

In a method according to the present invention, manufacturing the electrochromic composite layer (as defined above) is preferably carried out in a continuous, e.g. roll-to-roll manner.

In a method according to the present invention, preferably further layers of the intermediate product, e.g. the ion conductive separator layer and/or the layer capable of reversibly inserting ions, are manufactured by wet-processing, especially including a step of coating or printing, too.

The manufacturing of electrochromic devices starting from the intermediate products (finishing) is generally known.

In specific cases, manufacturing of an electrochromic device starting from an intermediate product which comprises a multitude of layers consisting of (in the order of stacking):
a first substrate
an electrochromic composite layer disposed on said first substrate
an ion conductive separator layer
a layer capable of reversibly inserting ions disposed on said first substrate
a second substrate

comprises the step of laminating said intermediate product to a support layer or in a sandwich-like manner between a first support layer and a second support layer. Said support layers preferably comprise one or more materials selected from the group consisting of glasses, metals and organic polymers. Adhesion between the support layer and the multitude of layers as defined above may be achieved by means of applying a suitable adhesive. As regards specific and preferred features of said support layers and adhesives, reference is made to the description provided in the context of the first aspect of the present invention.

Preferred methods according to the present invention are those wherein two or more of the above-defined preferred features are combined.

In the following, specific embodiments of the present invention are described:
1. An intermediate product for manufacturing an electrochromic device, said intermediate product comprising
   an electrochromic composite layer
   a substrate layer upon which the electrochromic composite layer is disposed wherein said electrochromic composite layer comprises
   matrix formed of one or more organic polymers and dispersed within said matrix:
   nanoobjects comprising one or more electrochromic metal oxides,
   one or more metal salts of formula (I)

(M^{a+})_{z}(R^{b-})_{y} (I),
wherein
M^{a+} represents a metal cation,
R^{b-} represents the corresponding salt anion,
a is 2, 3, 4 or 5,
b is 1, 2 or 3,
z is the least common multiple of a and b, divided by a
y is the least common multiple of a and b, divided by b
wherein the molar fraction of metal ions M of the metal salts of formula (I) is in the range of from 0.02 to 6 mol %, based on the total amount of metal in the metal ions M of the metal salts of formula (I) and in the metal oxides in the nanoobjects
wherein at least a portion of said metal salts of formula (I) is physisorbed on the surfaces of said nanoobjects comprising one or more electrochromic metal oxides
optionally electronically conductive nanowires and
one or more electrolytes having cations selected from the group consisting of H⁺, Li⁺, Na⁺ and K⁺ dissolved in a solvent having a boiling point of 120° C. or higher.
2. Intermediate product according to embodiment 1, wherein
   said organic polymers forming said matrix are copolymerisation products of monomers selected from the group consisting of alkyl acrylates and alkyl methacrylates and monomers selected from the group of hydroxyalkyl acrylates and hydroxyalkyl methacrylates
   and/or
   said electronically conductive nanowires are nanowires consisting of materials selected from the group consisting of silver, copper, gold, platinum, tungsten and nickel and alloys of two or more metals selected from silver, copper, gold, platinum, tungsten and nickel
   and/or
   said one or more electrolytes are selected from the group consisting of bis(trifluoromethane)sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, water and lithium difluorobisoxalatophosphate
   and/or
   said solvent having a boiling point of 120° C. or higher is selected from the group consisting of acyclic carbonates, alkyl esters of saturated carbonic acids, polyethers, lactones and dinitriles and mixtures thereof.
3. The intermediate product according to any of embodiments 1 and 2, wherein said electrochromic metal oxides are selected from the group consisting of oxides of Ti, V, Cr, Mn, Fe, Co, Ni, Nb, Mo, Rh, Ta, W and Ir and mixtures thereof.
4. The intermediate product according to any of embodiments 1 to 3, wherein in said metal salts of formula (I)
   M represents one of Zn, Al, Sc, Ga, Y, Pb, Bi, Cu, Ni, Co, Fe, Mn, Cr, V, Ti, La, Mg, Ca, Sr and Ba;
   and/or
   R represents an organic anion, preferably selected from the group consisting of acetate, formiate, citrate, and oxalate, or an inorganic anion, preferably selected from the group consisting of nitrate, difluorophosphate, hexafluorophosphate and tetrafluroborate.
5. The intermediate product according to any of embodiments 1 to 4, wherein the metal salt of formula (I) is selected from the group consisting of zinc diacetate, aluminium triacetate, yttrium triacetate, zinc dinitrate, aluminium trinitrate, and yttrium trinitrate.
6. The intermediate product according to any of embodiments 1 to 5, wherein said substrate layer comprises one or more materials selected from the group consisting of glasses, metals and organic polymers.
7. The intermediate product according to any of embodiments 1 to 6, further comprising an ion conductive separator layer disposed on said electrochromic composite layer.
8. The intermediate product according to any of embodiments 1 to 7, comprising a multitude of layers consisting of in the order of stacking:
   a first substrate
   an electrochromic composite layer
   an ion conductive separator layer
   a layer capable of reversibly inserting ions
   a second substrate.
9. The intermediate product according to embodiment 8, wherein in said electrochromic device said layer capable of reversibly inserting ions is a second electrochromic composite layer as defined in any of embodiments 1 to 5.
10. An electrochromic device,
   wherein said electrochromic device comprises a multitude of layers,
   said multitude of layers comprising
      an electrochromic composite layer
      a substrate layer upon which the electrochromic composite layer is disposed,
      a layer capable of reversibly inserting ions,
      an ion conductive separator layer disposed between and electronically separating said electrochromic composite layer and said layer capable of reversibly inserting ions
   characterized in said electrochromic device comprises an intermediate product according to any of embodiments 1 to 9.
11. The device according to embodiment 10, wherein the device is selected from the group consisting of fagade and roof elements, interior construction and design elements for buildings or vehicles, displays and visualization optics, and electrochromic mirrors.
12. Use of an intermediate product according to any of embodiments 1 to 9 for manufacturing an electronic device according to embodiment 10 or 11.
13. A composition in the form of a suspension comprising
   (a) nanoobjects comprising one or more electrochromic metal oxides
   (b) one or more metal salts of formula (I) as defined in embodiments 1, 4 and 5
   (c) a non-polymerizable carrier liquid having a boiling point of less than 120° C.,
   (d) optionally electronically conductive nanowires
   (e) two or more kinds of co-polymerizable monomers
   (f) one or more electrolytes having cations selected from the group consisting of H⁺, Li⁺, Na⁺ and K⁺
   (g) a solvent having a boiling point of 120° C. or higher capable of dissolving said one or more electrolytes (f).
14. Use of a composition in the form of a suspension as defined in embodiment 13 for manufacturing of an intermediate product according to any of embodiments 1 to 9;
   or for manufacturing an electrochromic device according to embodiment 10 or 11.
15. A method for manufacturing an intermediate product according to any of embodiments 1 to 9 or an electrochromic device according to embodiment 10 or 11, wherein manufacturing the electrochromic composite layer comprises the steps of
   (i) forming on a surface of a substrate a wet film by applying a suspension according to embodiment 13 to said surface of said substrate layer
   (ii) removing the non-polymerizable carrier liquid having a boiling point of less than 120° C. from said wet film formed on said surface of said substrate layer and
   (iii) initiating and allowing to proceed copolymerization of said two or more kinds of co-polymerizable monomers on the surface of said substrate layer.
16. The method of embodiment 15, wherein
   in step (i) the suspension is applied by coating or printing;
   and/or
   in step (ii) the non-polymerizable carrier liquid having a boiling point of less than 120° C. is removed under air or a protecting gas;
   and/or
   in step (iii) said copolymerization is initiated by irradiation.

1. An electrochromic device,
wherein said electrochromic device comprises a multitude of layers,
said multitude of layers comprising:
an electrochromic composite layer,
a substrate layer upon which said electrochromic composite layer is disposed,
a layer capable of reversibly inserting ions, and
an ion conductive separator layer disposed between and electronically separating said electrochromic composite layer and said layer capable of reversibly inserting ions,
wherein said electrochromic composite layer comprises:
a matrix formed of one or more organic polymers, and dispersed within said matrix:
nanoobjects comprising one or more electrochromic metal oxides,
one or more metal salts of formula (I)
(M^{a+})_{z}(R^{b-})_{y} (I),
wherein
M^{a+} represents a metal cation,
R^{b-} represents a corresponding salt anion,
a is 2, 3, 4 or 5,
b is 1, 2 or 3,
z is the least common multiple of a and b, divided by a, and
y is the least common multiple of a and b, divided by b,
wherein a molar fraction of metal ions M of said metal salts of formula (I) is in a range of from 0.02 to 6 mol %, based on a total amount of metal in said metal ions M of said metal salts of formula (I) and in said one or more electrochromic metal oxides in said nanoobjects,
wherein at least a portion of said metal salts of formula (I) is physisorbed on the surfaces of said nanoobjects comprising said one or more electrochromic metal oxides,
and
one or more electrolytes having cations selected from the group consisting of H⁺, Li⁺, Na⁺ and K⁺ dissolved in a solvent having a boiling point of 120° C. or higher.

2. An electrochromic device according to claim 1,
wherein said electrochromic composite layer further comprises:
electronically conductive nanowires.

3. An electrochromic device according to claim 1, wherein
said organic polymers forming said matrix are copolymerisation products of monomers selected from the group consisting of alkyl acrylates and alkyl methacrylates and monomers selected from the group of hydroxyalkyl acrylates and hydroxyalkyl methacrylates,
and/or
said electrochromic composite layer further comprises electronically conductive nanowires consisting of materials selected from the group consisting of silver, copper, gold, platinum, tungsten and nickel and alloys of two or more metals selected from silver, copper, gold, platinum, tungsten and nickel,
and/or
said one or more electrolytes are selected from the group consisting of bis(trifluoromethane)sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, water and lithium difluorobisoxalatophosphate,
and/or
said solvent having a boiling point of 120° C. or higher is selected from the group consisting of acyclic carbonates, alkyl esters of saturated carbonic acids, polyethers, lactones and dinitriles and mixtures thereof.

4. An electrochromic device according to claim 1, wherein said electrochromic metal oxides are selected from the group consisting of oxides of Ti, V, Cr, Mn, Fe, Co, Ni, Nb, Mo, Rh, Ta, W and Ir and mixtures thereof.

5. An electrochromic device according to claim 1, wherein in said metal salts of formula (I):
M represents one of Zn, Al, Sc, Ga, Y, Pb, Bi, Cu, Ni, Co, Fe, Mn, Cr, V, Ti, La, Mg, Ca, Sr and Ba;
and/or
R represents an organic anion.

6. An electrochromic device according to claim 1, wherein said metal salt of formula (I) is selected from the group consisting of zinc diacetate, aluminium triacetate, yttrium triacetate, zinc dinitrate, aluminium trinitrate, and yttrium trinitrate.

7. An electrochromic device according to claim 1, wherein in said electrochromic device said layer capable of reversibly inserting ions is a second electrochromic composite layer.

8. An electrochromic device according to claim 1, wherein said substrate layer comprises one or more materials selected from the group consisting of glasses, metals and organic polymers.

9. An electrochromic device according to claim 1, wherein said electrochromic device is selected from the group consisting of façade and roof elements, interior construction and design elements for buildings or vehicles, displays and visualization optics, and electrochromic mirrors.

10. An intermediate product for manufacturing an electrochromic device according to claim 1, said intermediate product comprising:
an electrochromic composite layer as defined in claim 1, and
a substrate layer upon which said electrochromic composite layer is disposed.

11. The intermediate product of claim 10, further comprising an ion conductive separator layer disposed on said electrochromic composite layer.

12. The intermediate product of claim 10, further comprising a multitude of layers consisting of, in the order of stacking:
a first substrate,
an electrochromic composite layer,
an ion conductive separator layer,
a layer capable of reversibly inserting ions, and
a second substrate.

13. A composition in the form of a suspension comprising:
(a) nanoobjects comprising one or more electrochromic metal oxides.
(b) one or more metal salts of formula (I) as defined in claim 1.
(c) a non-polymerizable carrier liquid having a boiling point of less than 120° C.,
(d) two or more kinds of co-polymerizable monomers,
(e) one or more electrolytes having cations selected from the group consisting of H⁺, Li⁺, Na⁺ and K⁺, and
(f) a solvent having a boiling point of 120° C. or higher capable of dissolving said one or more electrolytes (e).

14. A method of using a composition in the form of a suspension as defined in claim 13, the method comprising using said composition:
for manufacturing of an intermediate product according to claim 10; or
for manufacturing an electrochromic device according to claim 1.

15. A method for manufacturing an electrochromic device according to claim 1 or an intermediate product according to claim 10, wherein manufacturing the electrochromic composite layer comprises the steps of:
(i) forming on a surface of a substrate a wet film by applying a suspension according to claim 13 to said surface of said substrate layer;
(ii) removing the non-polymerizable carrier liquid having a boiling point of less than 120° C. from said wet film formed on said surface of said substrate layer; and
(iii) initiating and allowing to proceed copolymerization of said two or more kinds of co-polymerizable monomers on the surface of said substrate layer.

16. The method of claim 15, wherein
in step (i) the suspension is applied by coating or printing;
and/or
in step (ii) the non-polymerizable carrier liquid having a boiling point of less than 120° C. is removed under air or a protecting gas;
and/or
in step (iii) said copolymerization is initiated by irradiation.

17. An electrochromic device according to claim 5, wherein R represents an organic anion selected from the group consisting of acetate, formiate, citrate, and oxalate.

18. An electrochromic device according to claim 17, wherein R represents an inorganic anion selected from the group consisting of nitrate, difluorophosphate, hexafluorophosphate and tetrafluroborate.

19. A composition in the form of a suspension according to claim 13, said composition further comprising:
(g) electronically conductive nanowires.
